(19) United States
(12) Patent Application Publication
(10) Pub. No.: US 2004/0158844 A1
(43) Pub. Date: Aug. 12, 2004

(54) Optical disk player

(76) Inventors: Naohide Ohta, Ueda-shi (JP); Yosuke Kiyoto, Ueda-shi (JP)

Correspondence Address: BIRCH STEWART KOLASCH & BIRCH, PO BOX 747, FALLS CHURCH, VA, 22040-0747, US

(21) Appl. No.: 10/771,352

(22) Filed: Feb. 5, 2004

(30) Foreign Application Priority Data
Feb. 7, 2003 (JP) 2003-30859
Jan. 21, 2004 (JP) 2004-13393

(51) Int. Cl. G11B 33/02; G11B 17/04

(52) U.S. Cl. 720/603

(57) ABSTRACT

The optical disk player is capable of preventing vibrations of an optical disk and highly improving reliability of reading and/or writing data. The optical disk player, which is capable of writing data to and/or reading data from the optical disk, comprises: a tray having a mount section, in which the optical disk is mounted; and a top case covering over the mount section of the tray, the top case having a top plate, whose inner face is opposite to the optical disk, and a projected section, which is projected from the inner face of the top plate toward the optical disk.

### BACKGROUND OF THE INVENTION

The present invention relates to an optical disk player.

In an optical disk player, an optical disk is rotated at high rotational speed so as to writing and reading data at high speed. A centrifugal force works to the optical disk, and the optical disk has a multilayered structure. Therefore, the optical disk is deformed during rotation. There are two typical deformation modes. Namely, an outer part of the optical disk is warped upward with respect to a center part in one mode; and the outer part is warped downward with respect to the center part in the other mode. To solve problems caused by the deformations, a deviation between an optical axis of a laser beam, which is irradiated from an optical pick-up to an optical disk, and an optical axis of the reflected laser beam is measured, and a movement of the optical pick-up is controlled to follow the deformation (inclination) of the optical disk on the basis of the measured deviation. By this control, reliability of writing and reading data can be improved (see Japanese Patent Gazette No. 9-231595).

A method of improving reliability of writing data is disclosed in Japanese Patent Gazette No. 2000-322813. Amount of deformation of an optical disk is measured, data to be written are temporarily stored in a buffer memory when the amount of deformation exceeds an allowable deformation range. If the amount of deformation is reduced within the allowable range, the buffered data are written in the optical disk again. By this control, the reliability of writing data can be improved.

In the methods disclosed in the both Japanese Patent Gazettes, data can be correctly read and written as far as the mode and the amount of deforming the optical disk are within the expected range. However, the control systems performing the methods are required, so that manufacturing cost of the optical disk players must be increased.

Further, if a rotational speed of an optical disk corresponds to natural frequency thereof, the optical disk vibrates. The methods disclosed in the both Japanese Patent Gazettes cannot cope with the vibrations. In the conventional optical disk players, the reliability of reading and writing data cannot be highly improved.

### SUMMARY OF THE INVENTION

An object of the present invention is to provide an optical disk player, which is capable of preventing vibrations of an optical disk and highly improving reliability of reading and/or writing data.

The inventors of the present invention found that a centrifugal force generates air streams in an optical disk player when an optical disk is rotated at high speed, and pressure caused by the air streams restrain the vibration of the optical disk.

Namely, the optical disk player, which is capable of writing data to and/or reading data from an optical disk,

comprises:

a tray having a concaved mount section, in which the optical disk is mounted; and

a top case covering over the mount section of the tray, the top case having a top plate, whose inner face is opposite to the optical disk, and a projected section, which is projected from the inner face of the top plate toward the optical disk.

With this structure, the air stream in the optical disk player can be controlled, so that an upper surface of the optical disk can be pressed by air pressure. By pressing the optical disk, vibrations of the optical disk can be restrained, and reliability of reading and/or writing data can be highly improved.

Another optical disk player, which is capable of writing data to and/or reading data from an optical disk,

comprises:

a tray having a concaved mount section, in which the optical disk is mounted, the tray having a first projected section, which covers an outer circumferential face of the optical disk mounted in the mount section; and

a top case covering over the mount section of the tray, the top case having a top plate, whose inner face is opposite to the optical disk, and a second projected section, which is projected from the inner face of the top plate toward the optical disk.

With this structure, the air streams in the optical disk player can be controlled, so that an upper surface and a lower surface of the optical disk can be pressed by air pressure. By pressing the optical disk from the both sides, vibrations of the optical disk can be effectively restrained, and reliability of reading and/or writing data can be highly improved.

In the optical disk player, the projected section or projected sections may correspond to at least one fourth of a circumference of the optical disk. With this simple structure, the vibrations of the optical disk can be effectively restrained.

In the optical disk player, a distance between the projected section of the top case and the optical disk may be equal to that between an inner bottom face of the mount section and a surface of the optical disk facing the inner bottom face of the mount section. With this structure, the pressure working to the upper surface of the optical disk and the pressure working to the lower surface there of can be balanced, so that the vibrations can be restrained and deformation of the optical disk can be easily maintained in the expected mode.

In the optical disk player, a level of a front end face of the first projected section may be higher than that of a front end face of the second projected section. With this structure, the air streams in the optical disk player can be circulated, so that the fixed pressure can be applied to the optical disk.

In the optical disk player, the projected section or the projected sections may be provided on a side of inserting and ejecting the optical disk. With this structure, the projected section of the tray does not engaged with the top case when the optical disk is inserted and ejected. Further, even if the optical disk is broken during rotation, no broken pieces are scattered toward a user. A safe optical disk player can be realized.

### BRIEF DESCRIPTION OF THE DRAWINGS

Embodiments of the present invention will now be described by way of examples and with reference to the accompanying drawings, in which:

FIG. 1 is an exploded perspective view of an optical disk player of a first embodiment of the present invention;

FIG. 2 is a plan view of a tray shown in FIG. 1;

FIG. 3 is a bottom view of a top case shown in FIG. 1;

FIG. 4 is a schematic sectional view of the optical disk player;

FIGS. 5A-5C are graphs showing vibrations of optical disks mounted in the optical disk players of the first embodiment and a conventional disk player, wherein the optical disks are deformed upward;

FIGS. 6A-6C are graphs showing vibrations of optical disks mounted in the optical disk players of the first embodiment and the conventional disk player, wherein the optical disks are deformed downward;

FIG. 7 is an exploded perspective view of a top case of a second embodiment; and

FIG. 8 is a perspective view of the assembled top case shown in FIG. 7.

### DETAILED DESCRIPTION OF THE EMBODIMENTS

Preferred embodiments of the present invention will now be described in detail with reference to the accompanying drawings.

(First Embodiment)

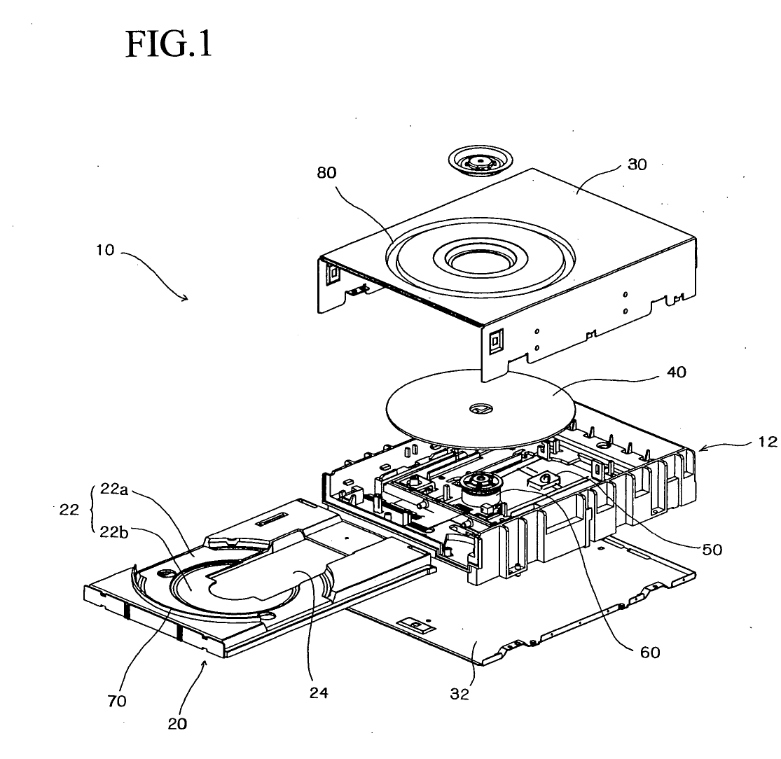

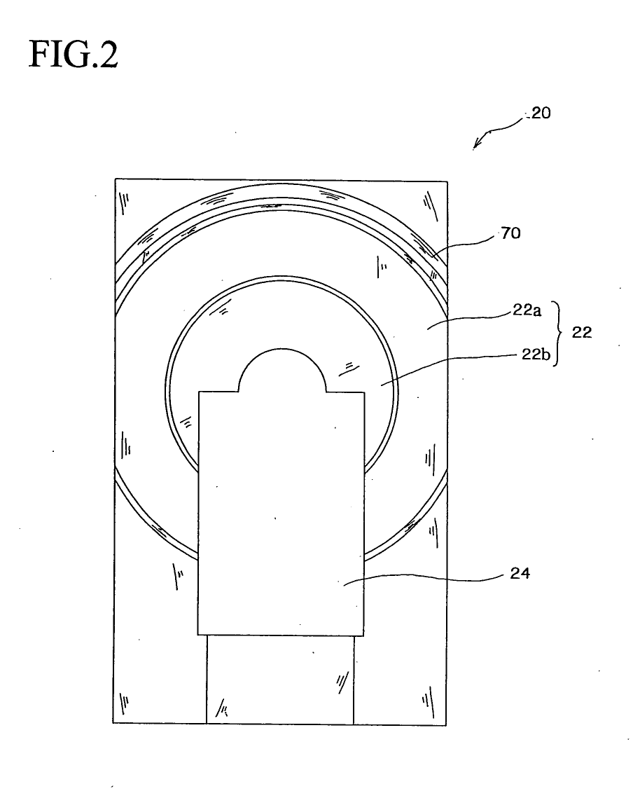

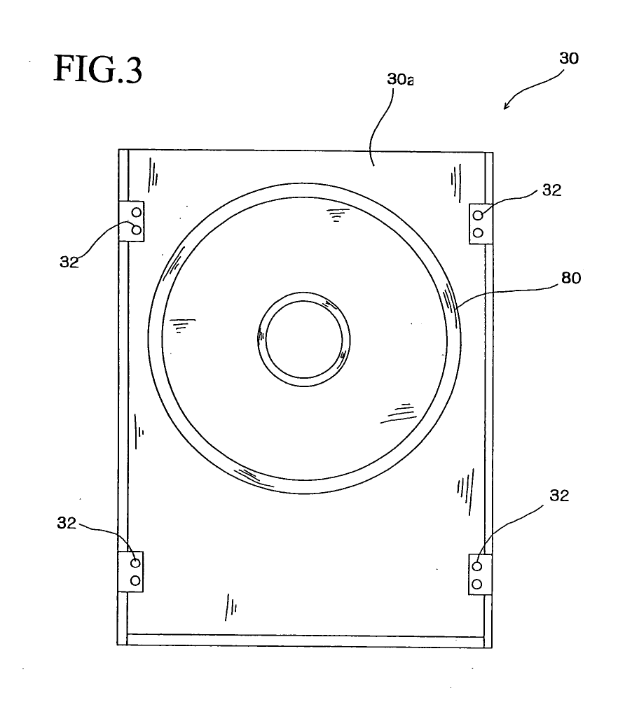

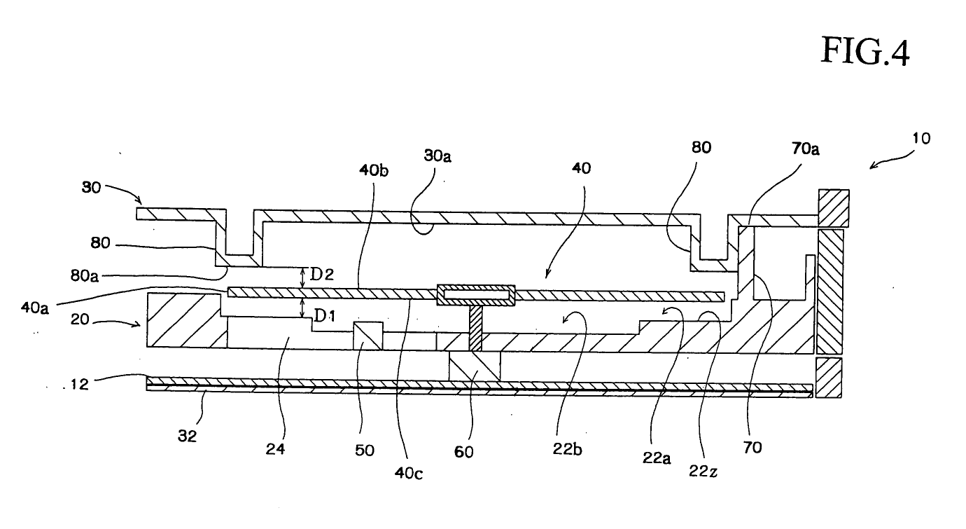

A first embodiment will be explained with reference to FIGS. 1-4. FIG. 1 is an exploded perspective view of an optical disk player of the present embodiment; FIG. 2 is a plan view of a tray; FIG. 3 is a bottom view of a top case; and FIG. 4 is a schematic sectional view of the optical disk player.

The optical disk player 10 has: a body proper 12; a tray 20, which can be inserted into and ejected from the body proper 12 and which includes a concaved mount section 22 in which an optical disk 40 can be mounted; a top case 30 covering over an upper face of the body proper 12; a bottom case 32 covering over a bottom face of the body proper 12; an optical pick-up 50, which is assembled in the body proper 12 and which reads data from and writes data on the optical disk 40; a spindle motor 60 for rotating the optical disk 40; and other components constituting ordinary optical disk players.

The tray 20 will be explained.

The tray 20 has: the concaved mount section 22, on which the optical disk 40 is mounted; and an opening section 24, in which the optical pick-up 50 is moved in the radial direction of the optical disk 40.

The mount section 22 has two concave portions 22a and 22b. The optical disk 40 having a diameter of 12 cm can be mounted in the concave part 22a; the optical disk 40 having a diameter of 8 cm can be mounted in the concave part 22b. A center of the concave part 22b is communicated to the opening section 24, and the spindle motor 60 is provided to the center of the concave part 22b.

A first projected section 70 is upwardly projected from the tray 20. The first projected section 70 is located closed to an outer edge of the concave part 22a and slightly located outside of an outer circumferential face of the optical disk 40. The projected section 70 is provided in a front part (an upper part of FIG. 2) of the tray 20 and extended along the outer edge of the concave part 22a. A preferable length of the projected section 70 is one third of an outer circumference of the concave part 22a or more. Further preferably, the projected section 70 is located close to a second projected section 80 of the top case 30.

As shown in FIG. 4, the projected section 70 contacts a bottom face of a top plate 30a of the top case 30, which covers the body proper 12.

Next, the top case 30 will be explained.

The second projected section 80 is provided in the bottom face of the top plate 30a of the top case 30. The second projected section 80 is located closed to an outer edge of the 12 cm optical disk 40 and slightly located inside of the outer circumferential face of the 12 cm optical disk 40. The second projected section 80 is downwardly projected toward the optical disk 40 from the bottom face of the top plate 30. A distance between an end face 80a of the projected section 80 and an upper face 40b of the optical disk 40 is equal to a distance between an inner bottom face 22z of the concave part 22a of the tray 20 and a bottom face 40c of the optical disk 40 mounted in the mount section 22 (D1=D2).

Preferably, the projected section 80 corresponds to the projected section 70 of the tray 20. The projected section 80 may be circularly formed, on the bottom face of the top plate 30a of the top case 30, along the outer circumferential face 40a of the optical disk 40 as shown in FIG. 3. Note that, symbols 32 stands for screws for assembling the top case 30.

Preferably, the first projected section 70 of the tray 20 and the second projected section 80 of the top case 30 are adjacently arranged. At least, a level of an upper end 70a of the projected section 70 is equal to that of a lower end 80a of the projected section 80. Preferably, the level of the upper end 70a of the projected section 70 is higher than that of the lower end 80a of the projected section 80. Namely, the projected sections 70 and 80 are capable of engaging each other (see FIG. 4).

The tray 20 is formed by a resin molding die, which has a part for forming the first projected section 70. Further, the projected section 70 may be separately formed, with resin, as a part, and the part may be adhered to a conventional tray.

The second projected section 80 of the top case 30 too may be separately formed, with resin, as a part, and the part may be adhered to a conventional top case. If the top case 30 is formed by a press die having a part for forming the second projected section 80, the top case 30 and the projected section 80 can be simultaneously formed, and the position of the projected section 80 can be precisely designed. Therefore, cost of manufacturing the top case 30 can be reduced.

Functions of the first and the second projected sections 70 and 80 will be explained.

The optical disk 40 mounted in the mount section 22 of the tray 20 is rotated by the spindle motor 60. When the rotational speed of the optical disk 40 reaches a prescribed speed, the optical pick-up 50 begins to read data from or write data onto the optical disk 40.

Rotation of the optical disk 40 is controlled by a known control method, e.g., a CAV (Constant Angular Velocity) process, a CLV. (Constant Linear Velocity) process.

By rotating the optical disk 40, a centrifugal force is generated, and it radially outwardly works to the optical disk 40. Therefore, air in the optical disk player 10 is moved from the center of the optical disk 40 toward the outer edge thereof by the centrifugal force.

In the present embodiment, the first projected section 70 of the tray 20 contacts the bottom face of the top plate 30a of the top case 30. With this structure, the air, which has moved from the center of the optical disk 40 to the outer edge thereof, collides with the projected sections 70 and 80 without irregularly spreading in the optical disk player 10, so that the air streams regularly turn in the direction perpendicular to the surfaces of the optical disk 40. Namely, the surfaces 40b and 40c of the optical disk 40 are pressed by air pressure caused by the air streams. In other words, the optical disk 40 is clamped by the air streams, so that vibrations of the optical disk 40 can be restrained.

As described above, the distances D1 and D2 are almost equal (see FIG. 4), so the air pressure working to the surface 40b and the air pressure working to the surface 40c can be almost equal. Therefore, the optical disk 40 can be clamped with the same air pressure, and the vibrations of the optical disk 40 can be effectively restrained.

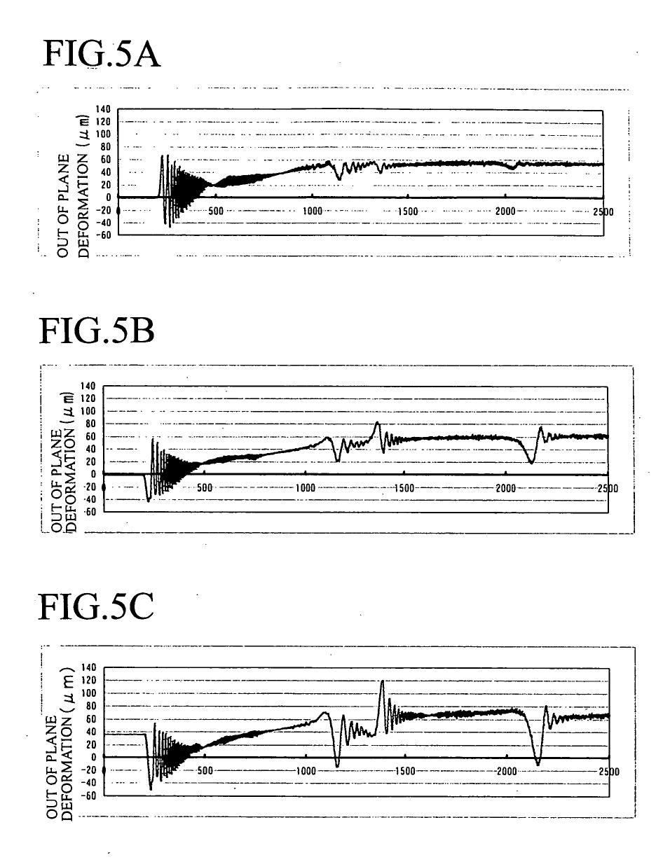

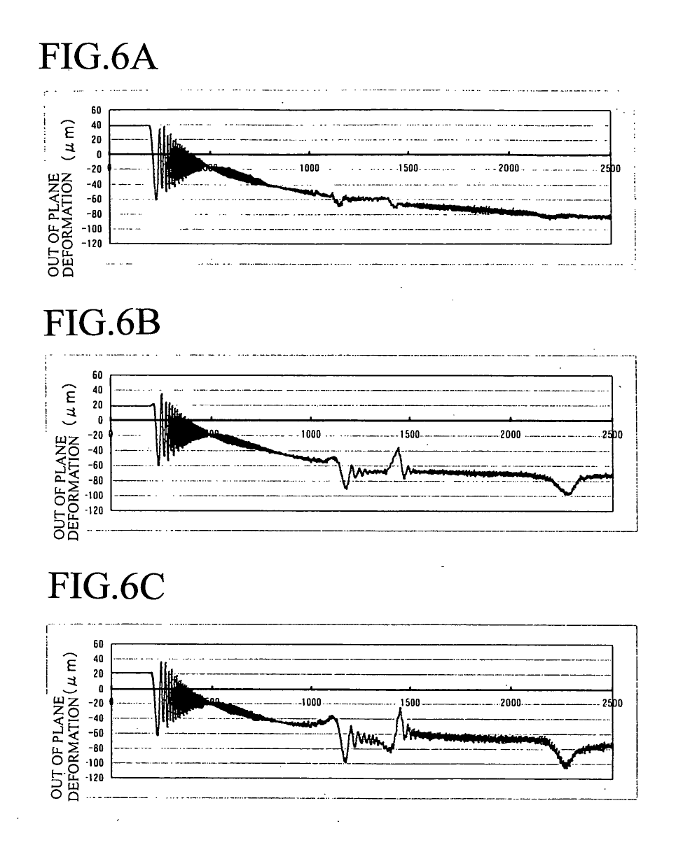

FIGS. 5A-5C and 6A-6C are graphs showing vibrations (out-of-plane deformations) of the optical disks 40 mounted in the optical disk players 10 of the first embodiment and a conventional disk player with respect to the rotational speed of the optical disks 40. The axes of abscissas indicate time of sampling data; the axes of ordinates indicate amounts of out-of-plane deformations. Note that, the time of sampling data is not merely in proportion to the rotational speed of the rotational speed of the optical disk 40. For example, 1000 of the axis of abscissas corresponds to the rotational speed of 6000 rpm, and 2500 of the axis of abscissas corresponds to the rotational speed of 10000 rpm.

FIGS. 5A and 6A show results of experiments performed in the optical disk player having the first and the second projected sections 70 and 80; FIGS. 5B and 6B show results of experiments performed in the optical disk player having the projected section 80 of the top case only; and FIGS. 5C and 6C show results of experiments performed in the conventional disk player having no projected sections. Note that, in FIGS. 5A-5C, the optical disks were upwardly deformed; in FIGS. 6A-6C, the optical disks were downwardly deformed.

Firstly, FIGS. 5A-5C will be explained. In FIGS. 5A-5C, great vibrations of the optical disks other than the typical deformation modes were observed in the time range of 1000-1500; in FIGS. 5B and 5C, similar great vibrations were observed in the time range of 2000-2200. Amplitudes of the vibrations in the time range of 1000-1500 shown in FIGS. 5A and 5B were much smaller than those shown in FIG. 5C. Further, almost no vibrations were observed in the time range of 2000-2200 shown in FIG. 5A

As clearly shown in FIGS. 5B and 5C, the amplitude of the vibrations of the optical disk player having the projected section 80 of the top case 30 only (FIG. 5B) can be limited to a half of those of the conventional disk player (FIG. 5C).

Next, FIGS. 6A-6C will be explained. In FIGS. 6A-6C too, great vibrations of the optical disks other than the typical deformation modes were observed in the time range of 1000-1500. Further, in FIGS. 5B and 5C, vibrations of the optical disks were observed around the time 2300.

Amplitudes of the vibrations in the time range of 1000-1500 shown in FIGS. 6A and 6B were much smaller than those shown in FIG. 6C. Amplitudes of the vibrations around the time 2300 shown in FIG. 6B were smaller than those shown in FIG. 6C. Note that, almost no vibrations were observed around the time 2300 shown in FIG. 6A.

According to FIGS. 6B and 6C, the amplitude of the vibrations of the optical disk player having the projected section 80 of the top case 30 only (FIG. 6B) can be limited to a half of those of the conventional disk player (FIG. 6C) as well as FIGS. 5B and 5C.

In the first embodiment, the first projected section 70 is formed in the tray 20, and the second projected section 80 is formed in the top case 30 so as to control the air streams in the optical disk player 10. so that the optical disk 40 is clamped by the air pressure caused by the air streams, and the vibrations of the optical disk 40 other than the typical deformation modes can be effectively restrained during the high speed rotation of the optical disk 40.

The projected section 80 of the top case 30 can be formed by press machining, so manufacturing cost of the top case 30 is not increased; the projected section 70 of the tray 20 is formed by resin molding or adhering the part, so manufacturing cost must be increased.

As clearly shown in FIGS. 5B, 5C, 6B and 6C, the amplitude of the vibrations of the optical disk player having the projected section 80 of the top case 30 only can be limited to a half of those of the conventional disk player, so only the projected section 80 may be formed in the top case 30 so as to reduce the manufacturing cost.

In the present embodiment, the height of the projected section 70 is designed to contact the bottom face of the top plate 30a of the top case 30, but the height is not limited to that height. If the upper end 70a of the first projected section 70 is located on the top case 30 side with respect to the lower end 80a of the second projected section 80, the effects of the present embodiment can be gained. Namely, the upper end 70a of the projected section 70 need not contact the bottom face of the top plate 30a of the top case 30.

In the present embodiment, the projected section 80 of the top case 30 is located slightly inside of the outer circumferential face 40a of the 12 cm optical disk 40, but the projected section 80 may be located slightly outside of the outer circumferential face 40a of the 12 cm optical disk 40. The similar effects can be gained.

In the present embodiment, the projected sections 70 and 80 are adjacently arranged, but they may be separately arranged if the air streams caused by the centrifugal force can circulate in the optical disk player 10.

(Second Embodiment)

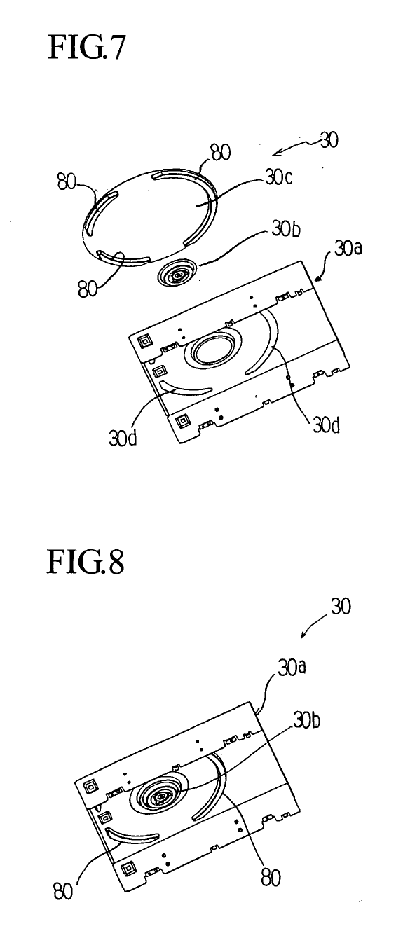

A second embodiment will be explained with reference to FIGS. 7 and 8. FIG. 7 is an exploded perspective view of a top case of the second embodiment; and FIG. 8 is a perspective view of the assembled top case shown in FIG. 7. Note that, the structural elements explained in the first embodiment are assigned the same symbols, and explanation will be omitted.

In the first embodiment, the projected section 80 is integrated with the top case 30; in the second embodiment, the projected sections 80 are formed in a pulley cover 30c constituting the top case 30. The projected section 80 is engaged with the top plate 30a, so that the top case 30 can have the projected sections 80.

As shown in FIG. 7, the top case 30 includes: the top plate 30a; a pulley 30b for pressing the optical disk set in the optical disk player; the pulley cover 30c for pressing the pulley 30b onto an upper face of the top plate 30a.

The pulley 30b is set in the top plate 30a, then the pulley cover 30c is set in setting holes 30d and fixed by screws, so that the pulley cover 30c covers the pulley 30b and presses the pulley 30b onto the top plate 30a.

The projected sections 80 are located slightly inside of the outer edge of the optical disk (not shown), which is clamped by the pulley 30b as well as the position of the second projected section 80 of the first embodiment. The projected sections 80 are downwardly projected from the top case 30. The projected sections 80 may be formed by the methods described in the first embodiment. The top plate 30a has the holes 30d, whose shapes and positions correspond to those of the projected sections 80 of the top case set at a prescribed position.

Sealing members may be provided in the vicinity of the set holes 30d and/or base parts of the projected sections 80 so as to air-tightly seal the top plate 30a and the pulley cover 30c.

By employing the top case 30 including the top plate 30a and the pulley cover 30c, the projected sections 80 formed in the pulley cover 30c project from the bottom face of the top plate 30a (see FIG. 8). Therefore, the top case 30 having the projections 80, whose function is similar to that of the top case 30 of the first embodiment, can be produced with low manufacturing cost.

The invention may be embodied in other specific forms without departing from the spirit or essential characteristics thereof. The present embodiments are therefore to be considered in all respects as illustrative and not restrictive, the scope of the invention being indicated by the appended claims rather than by he foregoing description and all changes which come within the meaning and range of equivalency of the claims are therefore intended to be embraced therein.

What is claimed is:

1. An optical disk player, which is capable of writing data to and/or reading data from an optical disk,
comprising:
a tray having a concaved mount section, in which the optical disk is mounted; and
a top case covering over the mount section of said tray, said top case having a top plate, whose inner face is opposite to the optical disk, and a projected section, which is projected from the inner face of the top plate toward the optical disk.

2. An optical disk player, which is capable of writing data to and/or reading data from an optical disk,
comprising:
a tray having a concaved mount section, in which the optical disk is mounted, said tray having a first projected section, which covers an outer circumferential face of the optical disk mounted in the mount section; and
a top case covering over the mount section of said tray, said top case having a top plate, whose inner face is opposite to the optical disk, and a second projected section, which is projected from the inner face of the top plate toward the optical disk.

3. The optical disk player according to claim 1,
wherein said projected section corresponds to at least one fourth of a circumference of the optical disk.

4. The optical disk player according to claim 2,
wherein said first projected section and/or said second projected section corresponds to at least one fourth of a circumference of the optical disk.

5. The optical disk player according to claim 1,
wherein a distance between said projected section and the optical disk is equal to that between an inner bottom face of the mount section and a surface of the optical disk facing the inner bottom face.

6. The optical disk player according to claim 2,
wherein a distance between said second projected section and the optical disk is equal to that between an inner bottom face of the mount section and a surface of the optical disk facing the inner bottom face.

7. The optical disk player according to claim 2,
wherein a level of a front end face of said first projected section is higher than that of a front end face of said second projected section.

8. The optical disk player according to claim 1,
wherein said projected section is provided on a side of inserting and ejecting the optical disk.

9. The optical disk player according to claim 2,
wherein said first projected section and/or said second projected section is provided on a side of inserting and ejecting the optical disk.
